(19) United States
(12) Patent Application Publication
(10) Pub. No.: US 2017/0127050 A1
(43) Pub. Date: May 4, 2017

(54) IMAGE DATA REDUNDANCY FOR HIGH QUALITY 3D

(71) Applicant: SHARP KABUSHIKI KAISHA, Osaka (JP)

(72) Inventors: Jonathan MATHER, Oxford (GB); Laura HUANG, (US); Alexander ZAWADZKI, (US); Nathan James SMITH, (US)

(21) Appl. No.: 15/320,146

(22) PCT Filed: Jun. 25, 2015
(86) PCT No.: PCT/JP2015/003194

§ 371 Date: Dec. 19, 2016

(30) Foreign Application Priority Data
Jun. 25, 2014 (GB) 1411281.7

(51) Int. Cl. H04N 13/04; G02B 3/08; G02B 3/00; G02B 27/22; G02B 27/00

(52) U.S. Cl. CPC H04N 13/0404; H04N 13/0409; H04N 13/0415; G02B 27/2214; G02B 27/0093; G02B 3/0037; G02B 3/08

(57) ABSTRACT

A multiple view directional display has an image display panel, a parallax optic and a control unit. The control unit is configured to address the image display panel to display first and second images on respective sets of X adjacent columns of pixels or sub-pixels. The parallax optic comprises parallax elements configured to allow a first region of the image display panel having a width of Y adjacent columns of pixels or sub-pixels to be visible to a left eye of a viewer, where Y≧3 and X−Y≧3, and to allow a second, different region of the image display panel having a width of Y adjacent columns of pixels or sub-pixels to be visible to a right eye of the viewer. Parallax elements of the parallax optic are inclined with respect to columns of pixels or sub-pixels of the image display panel.

### TECHNICAL FIELD

This invention relates to a multiple view directional display such as an autostereoscopic (glasses-free) 3D system that can maintain a 3D effect as a user's head moves left or right. The invention is compatible with parallax barrier systems and lenticular lens systems.

### BACKGROUND ART

For many years people have been trying to create better autostereoscopic 3D displays, and this invention provides a further advance in this field. An autostereoscopic display is a display that gives stereoscopic depth without the user needing to wear glasses. This is accomplished by projecting a different image to each eye. An autostereoscopic 3D display can be realised by using parallax optic technology such as a parallax barrier or lenticular lenses.

The design and operation of parallax barrier technology for viewing 3D images is well described in a paper from the University of Tokushima Japan (“Optimum parameters and viewing areas of stereoscopic full colour LED display using parallax barrier”, Hirotsugu Yamamoto et al., IEICE Trans Electron, vol E83-c no 10 Oct. 2000).

The design and operation of lenticular technology for viewing 3D images is well described in US20120229896.

FIGS. 1(a) and 1(b) show the basic design and operation of parallax barrier technology for use in conjunction with an image display for creating a 3D display. The images for the left eye and right eye are interlaced on alternate columns of pixels of the image display. The apertures in the parallax barrier allow the viewer to see only left image pixels from the position of their left eye and right image pixels from the position of their right eye.

A fixed parallax barrier or lens system has the disadvantage that the viewer observes a stereoscopic image only in strict viewing zones. Outside these zones, pixel information intended for the left eye may reach the right eye and vice versa. FIG. 2 (a) shows how the user can see the correct image, and FIG. 2 (b) shows how, as a result of sideways movement of the observer relative to the display, the user can see a pseudoscopic image where each eye sees light from the wrong pixel regions.

By tracking the positions of the user's eyes, the system can be adjusted in order to change the size and position of the viewing zones. These improvements can be achieved by changing the pixel values (that is, changing the data values supplied to the pixels of the display), or by changing the barrier parameters or a combination of both.

Mechanical tracking involves physically moving the parallax barrier or optics relative to the pixels and the screen. U.S. Pat. No. 6,377,295 and U.S. Pat. No. 5,083,199 describe how this might be achieved with a lenticular lens system and a parallax barrier system respectively. The authors of U.S. Pat. No. 6,377,295 note that mechanical tracking has drawbacks. Adding a mechanical element to the system is likely to increase the total system cost, whilst the dependence on moving parts will decrease the system robustness. Another concern is that the tracking speed of a mechanical system may not be fast enough to cope with rapid changes in user position.

Electrical tracking, such as discussed in EP0860729-B1, may be achieved by using a parallax barrier composed from a liquid crystal, and electrically addressing it in order to spatially change its transmission properties. Such a barrier has certain advantages: it involves no moving parts, and it may be switched into a transmissive state in order to give a full resolution 2D mode. This approach is not without drawbacks: making a high quality switchable LC barrier is technically very challenging. The shutter must be controllable on a scale smaller than the display's pixels, which is technically complex. The shutter cannot include any opaque features which might cause Moire problems with the underlying display in the 2D mode. Discrete switching of an electronic barrier may cause problems with the brightness uniformity of the resulting image.

Tracking pixel values underneath a stationary lens or barrier offers some attractive advantages over tracking barrier designs. Since a tracking barrier is not required the system may be simpler and cheaper—a printed parallax barrier of transmissive and opaque features can be used instead of an expensive and complex optical tracking system. The tracking speed of the system depends significantly on the speed of the image display, but mobile displays designed for video content already run at fast frame rates. Tracked pixel systems can be scaled up to large display sizes much more easily than tracked barrier type displays can be.

An early tracked pixel 3D display was disclosed by K Akiyama and N Tetsutani, “3-Dimensional Visual Communication”, ITEC'91, 1991 OTE Annual Convention. In this design, a lenticular lens sheet angularly multiplexes light from adjacent columns of pixels on a display. A position detector monitors the user's position, causing the display to switch the information displayed on the columns of pixels when the user moves out from the primary viewing window. This system greatly increases head freedom, but introduces a very visible artefact when users switch between viewing windows.

An improved system was disclosed by U.S. Pat. No. 5,959,664, whereby the image display contains right eye data, left eye data and some regions which are not seen by either eye. These redundant regions are extremely important, since they allow for increased Z-tolerance and smoother tracking. Instead of performing a visible left/right image data swap, the appropriate image data can be loaded into a region not yet visible to the observer. When the observer's head moves laterally the correct view information may then be seen, allowing for smooth tracking.

Even with these developments, current head tracking 3D technologies are far from perfect. In particular, adjusting for movements of the user towards or away from the display remains a major unsolved problem. Smooth tracking with good brightness uniformity remains another significant challenge.

JP 2012/053432 proposes a stereoscopic image display device that comprises: a display module in which first pixels and second pixels capable of displaying a first-direction image and a second-direction image, respectively, are alternately arranged in a horizontal direction; and a barrier module which is spaced apart from the display module by a predetermined distance and controls the driving of a barrier having oblique patterns arranged such that the left and right eyes of a viewer selectively see the first and second pixels, respectively, in the horizontal direction in units of pixels. The first and second pixels include sub-pixels displaying red light, green light and blue light, respectively, and the oblique patterns are configured such that the barrier is disposed at positions in which the sub-pixel units are continuously shifted toward either of the left side or the right side at every predetermined number of rows in the vertical direction when viewing the sequentially arranged first and second pixels in the form of a matrix.

WO2013/094192 proposes a display device including a display portion for displaying a composite image of left and right images to be viewed by left and right eyes by using display elements arranged in a matrix. The display portion defines first and second element groups for displaying the left and right images, respectively. The first element groups include first and second height group situated at first and second vertical positions, which is different from each other. The second element groups include first and second adjacent groups horizontally adjacent to the first and second height group, respectively. The first and second adjacent groups include first and second adjacent elements adjacent to the first and second height groups, respectively. The first adjacent element emits different light in a luminescent color from the second adjacent element.

US2013135719 proposes a stereo display device that includes a display panel and a parallax barrier panel. The display panel includes a pixel array having pixel units, each of which includes sub-pixels. The parallax barrier panel at one side of the display panel includes a first substrate, first electrodes, second electrodes, a second substrate, third electrodes, fourth electrodes, and a birefringence medium. The first and second electrodes are arranged on the first substrate alternately; an extension direction of the first and second electrodes is parallel to the X-direction. The third and fourth electrodes are arranged on the second substrate alternately; an extension direction of the third and fourth electrodes is not parallel to the X-direction; an included angle between the extension direction of the third and fourth electrodes and the Y-direction is substantially greater than 0° and smaller than 45°. The birefringence medium is disposed between the first and second substrates.

### SUMMARY OF INVENTION

In the prior art there is no such system that provides 3D with such good tracking, good brightness uniformity, and low Moire. The proposed invention shows significant improvements over the previous state of the art. In particular, using a slanted parallax optic solves Moire issues; using an integer sub-pixel repeat distance gives excellent brightness uniformity, minimizing the image repeat distance gives good image quality; using a parallax barrier aperture width of 3 sub pixels (R+G+B) prevents colour artefacts; and using the minimum necessary image redundancy (3 pixels) for tracking with the slanted barrier optimises the tracking smoothness/brightness trade-off. As an added benefit, the final system achieves better performance in a simpler manner than alternative tracking systems.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

The present invention provide a multiple view directional display comprising: an image display panel having a matrix of pixels or sub-pixels arranged in rows and columns; a parallax optic disposed in the path of light through the image display panel; and a control unit for addressing the pixels or sub-pixels; wherein the control unit is configured to address the image display panel to display a first image on a first set of X adjacent columns of pixels or sub-pixels and a second image on a second set of X adjacent columns of pixels which is different from the first; wherein the parallax optic comprises parallax elements configured to allow a first region of the image display panel having a width of Y adjacent columns of pixels or sub-pixels to be visible to a viewer's left eye wherein the first region comprises a sub-set of the first set of X adjacent columns and to allow a second region of the image display panel to be visible to the viewer's right eye, the second region of the image display panel being different to the first region and having a width of Y adjacent columns of pixels or sub-pixels wherein the second region comprises a sub-set of the second set of X adjacent columns; wherein Y≧3 and X−Y≧3; and wherein parallax elements of the parallax optic are inclined with respect to the columns of pixels or sub-pixels of the image display panel. The Y adjacent columns of pixels or sub-pixels constituting the first [second] region of the image display panel are a subset of the X adjacent columns of pixels or sub-pixels on which the first [second] image is displayed. Since the viewer's left eye and right eye see different regions of the image display panel, a display of the invention can operate as an autostereoscopic 3-D display by suitably addressing the image display panel.

The parallax elements may be configured so that the first region of the image display panel is preferably not visible to the right eye of the viewer, and the second region of the image display panel is preferably not visible to the left eye of the viewer, so as to provide a high quality autostereoscopic 3D display.

### BRIEF DESCRIPTION OF DRAWINGS

In the annexed drawings, like references indicate like parts or features:

FIG. 1 Prior Art

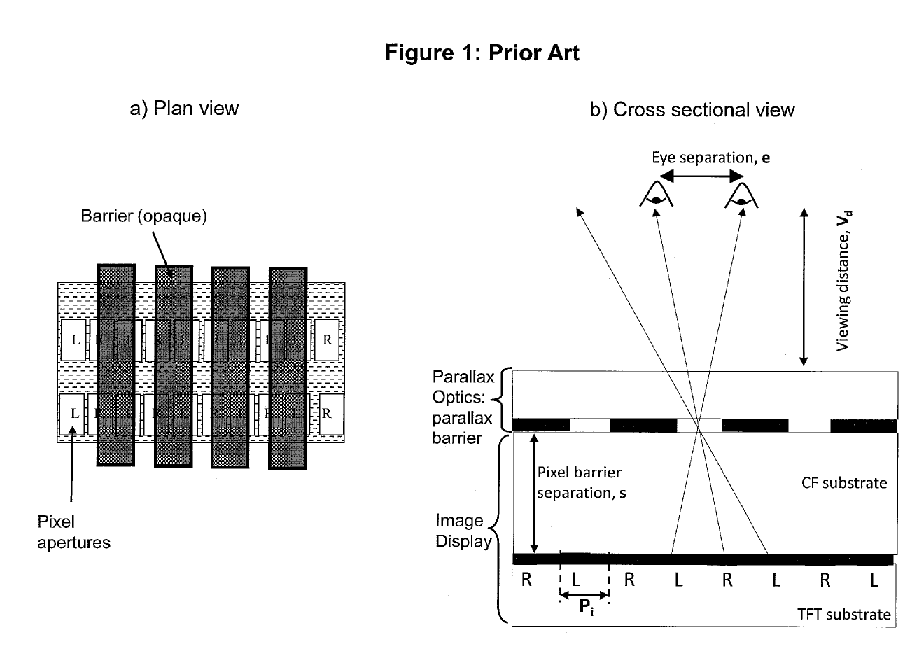

FIG. 2 Two Window Tracking System

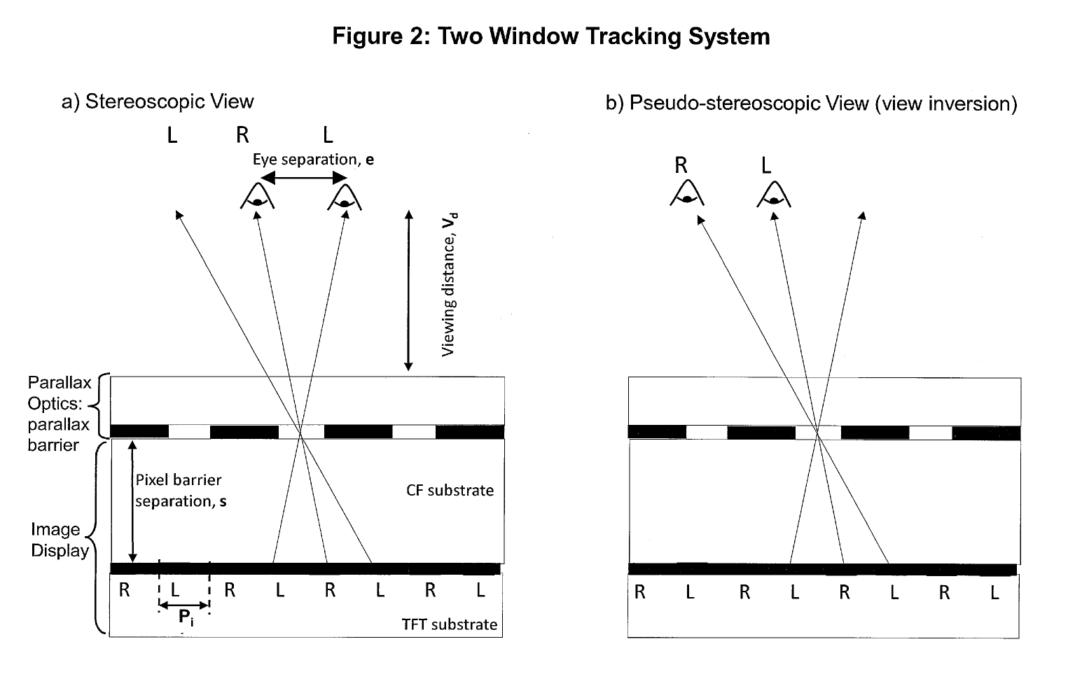

FIG. 3 NPX-Y Interlace Patterns

FIG. 4 Visible display area for assorted barrier systems

FIG. 5 Moire Effects

FIG. 6 Slanted Barriers

FIG. 7 Full Gamut ‘Pixel’ Location

FIG. 8 Brightness artefacts

FIG. 9 Minimum Redundancy

FIG. 10 3D Tracking System

FIG. 11 Visible display pixels (sub-pixels) for a multi-faceted lens system

FIG. 12 Visible display pixels (sub-pixels) in an NP6-3 3D head tracked system

### DESCRIPTION OF EMBODIMENTS

The invention is a 3D display designed for high quality 3D. It was developed to optimise the trade-off between many conflicting factors that are known to influence 3D display quality.

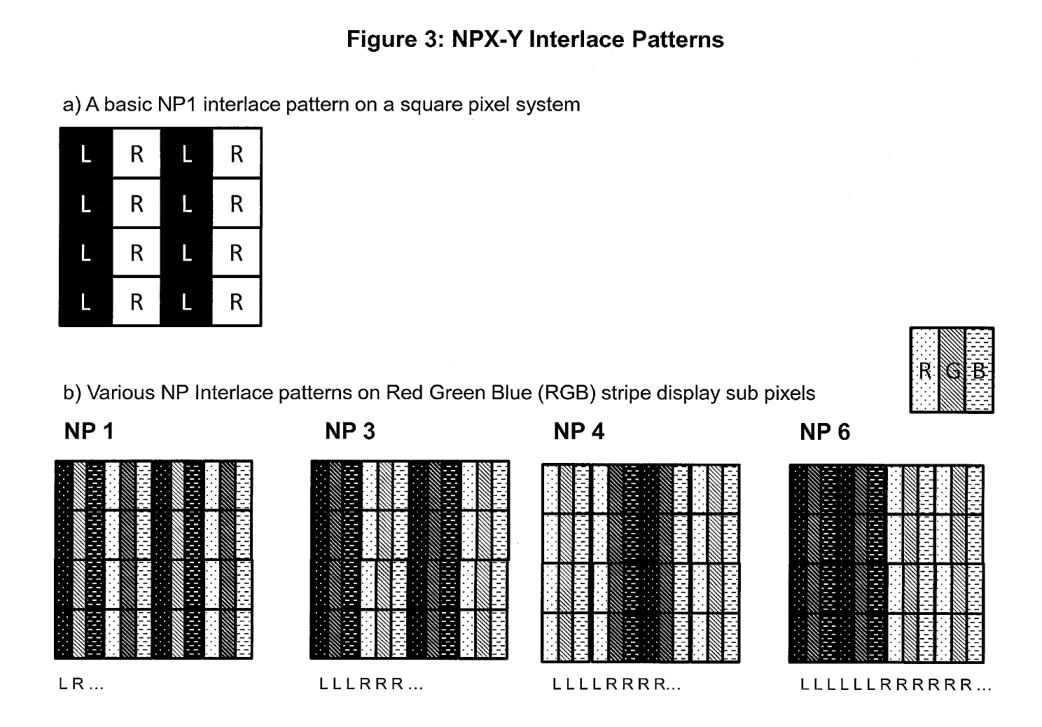

The naming convention used for interlacing patterns is based upon that used in “Development of Dual View Displays”, (Mather, 2007). For a NPX-Y system ‘X’ denotes the repeat image unit size in pixels or sub-pixels and, for a given parallax optic which may be a parallax barrier or lenticular (lens) array or prism array, the ‘Y’ denotes the number of pixels or sub-pixels visible by one eye. Where the parallax optic is a parallax barrier aperture array, the width of the parallax barrier aperture in terms of pixel pitch or sub-pixel pitch is equal, or substantially equal, to Y. A NP1 system has the pattern LRLR . . . where L is a pixel or sub-pixel with Left view data and R is a pixel or sub-pixel with Right view data. This is shown in FIG. 3a. A NP2 system is LLRRLLRR . . . FIG. 3b shows NP1, NP3, NP4 and NP6 interlace patterns on rectangular sub-pixels, the type used in most commercial flat-screen displays.

The inventors have found that a preferred system for an autostereoscopic display is a system that can be described as a “NP6-3 stag 1” system. The “six” denotes the repeating number of sub-pixels for the Left/Right interlace i.e. six consecutive left eye pixels or sub-pixels followed by six consecutive right eye pixels or sub-pixels. The “three” denotes that the parallax optic comprises parallax elements configured to allow a first region of the image display panel having a width of 3 adjacent columns of pixels or sub-pixels to be visible to a viewer. For example, in a display in which the parallax optic comprises a parallax barrier, the “three” denotes the barrier aperture width, in terms of sub-pixel pitch (i.e. a barrier aperture width of 3 sub-pixel pitches). The ‘stag 1’ denotes that parallax elements of the parallax optic are slanted or staggered with respect to columns of pixels or sub-pixels, with a slope of 1:1 pixels per row of pixels or 1:1 sub pixels per row of sub-pixels. Unless stated otherwise, it is assumed that the non-active portion of a pixel can be ignored so that the “width” of a pixel refers to the pixel pitch. Unless stated otherwise, it is assumed that the non-active portion of a sub-pixel can be ignored so that the “width” of a sub-pixel refers to the sub-pixel pitch. Unless stated otherwise, the terms pixel and sub-pixel are interchangeable.

This design is the result of extensive planning, modelling and experimental verification. It represents a trade-off between brightness, Moire, image resolution, colour artefacts and brightness uniformity.

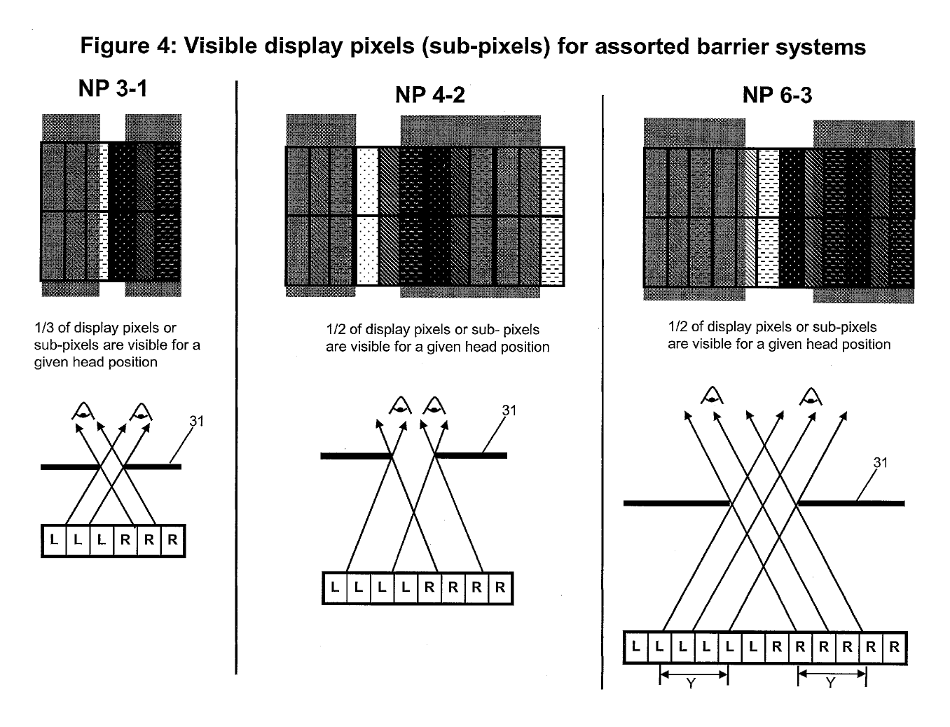

It is desirable to minimize the ratio of barrier to display in order to maximise the brightness of the display. FIG. 4 illustrates how an NP3-1 system has 33% of the pixels or sub-pixel visible through the parallax optic, which may be a parallax barrier 31, since the combination of a repeat unit having a size of 3 sub-pixels and a barrier aperture having a width of one sub-pixel requires opaque barrier regions having a width of two sub-pixels. In other words, for every group of 6 sub-pixels, the left eye sees a first sub-pixel and the right eye sees a second sub-pixel, which is different from the first sub-pixel and therefore 2 sub-pixels out of 6 sub-pixels are visible to the viewer. An NP4-2 system and an NP6-3 system have 50% of the pixels or sub-pixel visible through the parallax optic, which may be a parallax barrier 31. On this basis, the NP4-2 and NP6-3 systems are equally good, and both are superior to the NP3-1 system. For an NPX-Y system with a parallax barrier, a higher ratio of Y:X will result in less loss of light due to the parallax barrier and hence a brighter display.

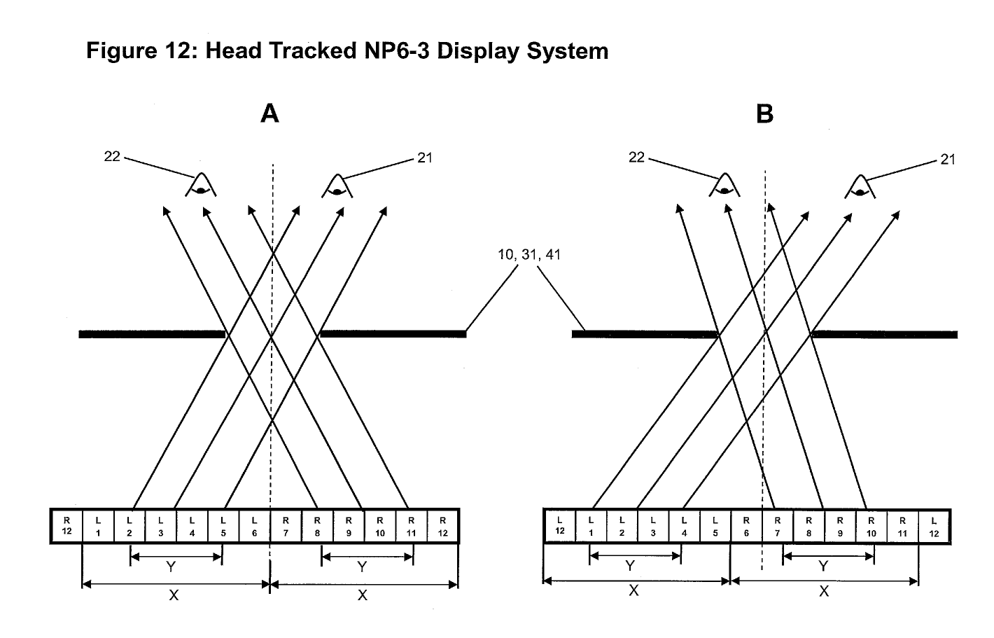

FIG. 4 and FIG. 12 illustrates that in an NP6-3 system where the parallax optic 41 is comprised of a parallax barrier 31 that has an aperture width equal to 3 sub-pixels (or pixels), a first set of sub-pixels (or pixels) with a width of 3 adjacent columns of sub-pixels (or pixels) is visible to a viewer's left eye while a second set of sub-pixels (or pixels), which is different from the first set, with a width of 3 adjacent columns of sub-pixels (or pixels) is visible to a viewer's right eye. The pitch of the parallax barrier is 2X (=12 in this example) columns of sub-pixels (or pixels)

The repeat unit of the NP6-3 system in FIG. 4 and FIG. 12 is comprised of 12 sub-pixels (or pixels) in total with 6 sub-pixels (or pixels) for the left eye (L) and 6 sub-pixels (or pixels) for the right eye (R). The 12 sub-pixels (or pixels) are labelled 1, 2, 3 etc. to 12 in FIG. 12. The image data “L” (left eye) or “R” (right eye) on any given sub-pixel (or pixel) are shown. The image data L or R on each respective sub-pixel (or pixel) may change with head position to ensure that for all head-positions left eye image data is observed with the viewer's left eye 21 and right eye image data is observed with the viewer's right eye 22. A first set of sub-pixels (or pixels) visible to the viewer's left eye may comprise 3 sub-pixels (or pixels) all of which are fully visible to the viewer's left eye or may comprise 4 sub-pixels (or pixels) of which two are fully visible to the viewer's left eye and two are partially visible to the viewer's left eye, but the region of the pixelated display visible to the viewer's left eye always has a width equal to 3 sub-pixels (or pixels), as shown by “Y” in FIG. 4 and FIG. 12. With reference to FIG. 12A, for a first given head position if the sub-pixels (or pixels) are labelled 1 to 12 in a periodic fashion (one complete period and the final sub-pixel (or pixel) of the previous period are shown in FIG. 12A) then the left eye image is addressed to sub-pixels (or pixels) 1 to 6 and right eye image is addressed to sub-pixels (or pixels) 7 to 12. Sub-pixel (or pixel) 1 is not visible to the viewer, half of sub-pixel (or pixel) 2 is visible to the viewer's left eye 21, all of sub-pixel (or pixel) 3 is visible to the viewer's left eye 21, all of sub-pixel (or pixel) 4 is visible is the viewer's left eye 21, half of sub-pixel (or pixel) 5 is visible to the viewer's left eye 21 and sub-pixel (or pixel) 6 is not visible to the viewer. Consequently, for this first given head position, 4 sub-pixels (or pixels) are visible to the viewer (L2, L3, L4 and L5) but the width of the display visible to the viewer's left eye is exactly 3 sub-pixels (or pixels)—the width visible being equal to half the width of L2+the width of L3+the width of L4+half the width of L5. By symmetry and similar argument, the width of the display visible to the viewer's right eye 22 is exactly 3 sub-pixels (or pixels) and comprises half the width of R8+the width of R9+the width of R10+half the width of R11. With reference to FIG. 12B, for a second given head position which is different to the first head position, a different set of sub-pixels (or pixels) may be visible to the viewer's left eye 21. As shown in FIG. 12B, half the width of L1+the width of L2+the width of L3+half the width of L4 are be visible to the viewer's left eye 21. By symmetry and similar argument, the width of the display visible to the viewer's right eye 22 is exactly 3 sub-pixels (or pixels) and comprises half the width of R7+the width of R8+the width of R9+half the width of R10. As shown in FIG. 12A and FIG. 12B, the image data for left eye (L) and right eye (R) has been changed by a control unit (not shown) in response to the viewer's head movement from the first head position in FIG. 12A and the second head position in FIG. 12B. Between the head positions shown by FIG. 12A and FIG. 12B is a third head position whereby exactly 3 sub-pixels (or pixels) are visible to the viewer's left eye (L2, L3 and L4) and exactly 3 sub pixels (or pixels) are visible to the viewer's right eye (R8, R9, R10). In an NP6-3 system, there is a first region of the pixelated display visible to the viewer's left eye with a width of Y sub-pixels (or pixels) and a second region of the pixelated display which is different to the first region, visible to the viewer's right eye again with a width of Y sub-pixels (or pixels).

The invention is not limited to a display in which the parallax optic 41 comprises a parallax barrier 31, but may be applied to displays having other forms of parallax optic. For example, instead of the parallax barrier 31 illustrated in FIG. 4, a lenticular lens array may be used to image the sub-pixels towards the viewer's eyes, with each lenticular lens having a width, parallel to the image display panel, of substantially 2X adjacent columns of pixels or sub-pixels (so that the parallax optic has a pitch of substantially 2X adjacent columns of pixels or sub-pixels) so as to allow a first region of the image display panel having a width of Y adjacent columns of pixels or sub-pixels to be visible to the viewer's left eye and a second region of the image display panel, which is different to the first region and which also has a width of Y adjacent columns of pixels or sub-pixels, to be visible the viewer's right eye.

Each lenticular lens may be comprised of multiple facets. The facets may be straight or curved.

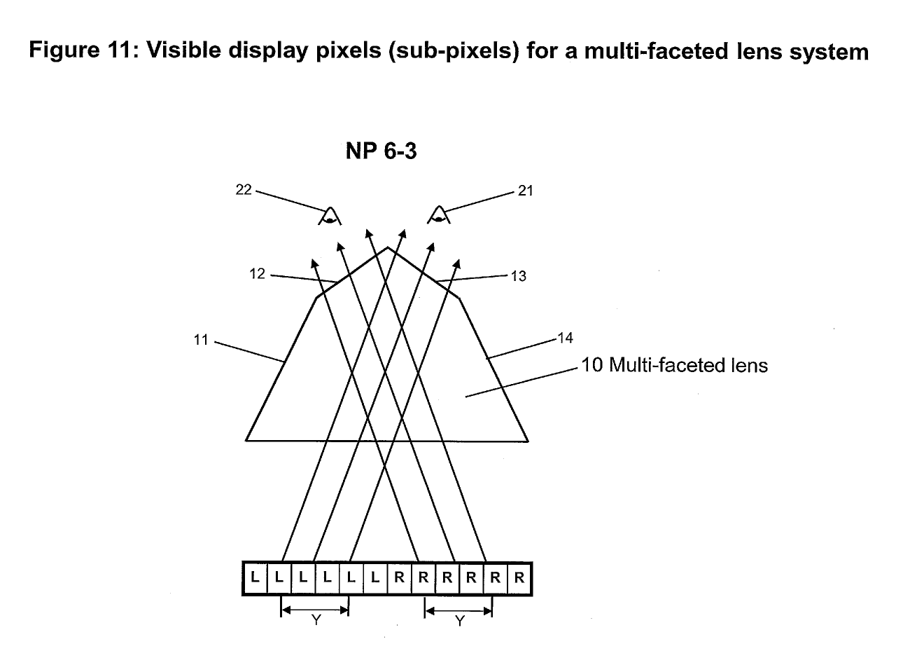

FIG. 11 illustrates an NP6-3 system with a multi-faceted lens 10. The lens is comprised of 4 facets (11, 12, 13 and 14) of equal width. The width of each facet may be equal to the width of Y (in this example Y=3) sub-pixels. If the width of each facet is equal to the width of Y sub-pixels (or pixels) then for every head position, there is a first region of the pixelated display visible to the viewer's left eye 21 with a width of Y sub-pixels (or pixels) and a second region of the pixelated display which is different to the first, visible to the viewer's right eye 22 with a width of Y sub-pixels (or pixels). The width of each facet may have a very small correction to compensate for viewing off-axis sub-pixels (i.e. pitch correction). Typically the pitch correction factor is <1%, therefore the width of a facet is substantially equal to the width of 3 sub-pixels. The width of each facet may be substantially equal to the width of the parallax barrier slit shown in the NP6-3 design of FIG. 4 and FIG. 12. FIG. 11 illustrates that in the NP6-3 system, for every group of 12 sub-pixels, the left eye 21 sees a first set of three sub-pixels and the right eye 22 sees a second set of 3 sub-pixels, which is different from the first set. The first set of sub-pixels is imaged through each lens facet (11, 12, 13 and 14) to the viewer's left eye 21. Imaging of the first set of sub-pixels through lens facet 13 is shown in FIG. 11. For diagram simplicity, imaging of the first set of sub-pixels through lens facets 11, 12 and 14 are not shown in FIG. 11. The second set of sub-pixels is imaged through each lens facet (11, 12, 13 and 14) to the viewer's right eye 22. Imaging of the second set of sub-pixels through facet 12 is shown in FIG. 11. For diagram simplicity, imaging of the second set of sub-pixels through facets 11, 13 and 14 are not shown in FIG. 11. The multi-faceted lens system using NP6-3 shown in FIG. 11 enables a brighter image to be viewed than the parallax barrier system using NP6-3 shown in FIG. 4. For this given head position, the other 6 sub-pixels of the group of 12 sub-pixels are not imaged to either eye of the viewer.

FIG. 11 illustrates that in an NP6-3 system where the parallax optic is comprised of a multi-faceted lens, a first set of sub-pixels (or pixels) with a width of 3 columns of sub-pixels (or pixels) is visible to a viewer's left eye 21 while a second set of sub-pixels (or pixels), which is different from the first set, with a width of 3 columns of sub-pixels (or pixels) is visible to a viewer's right eye 22.

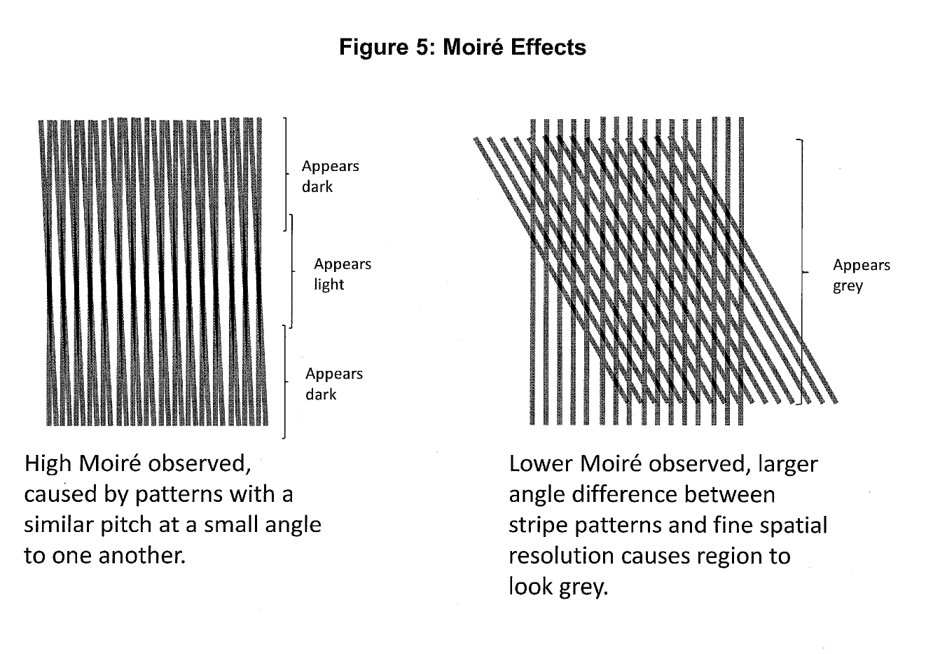

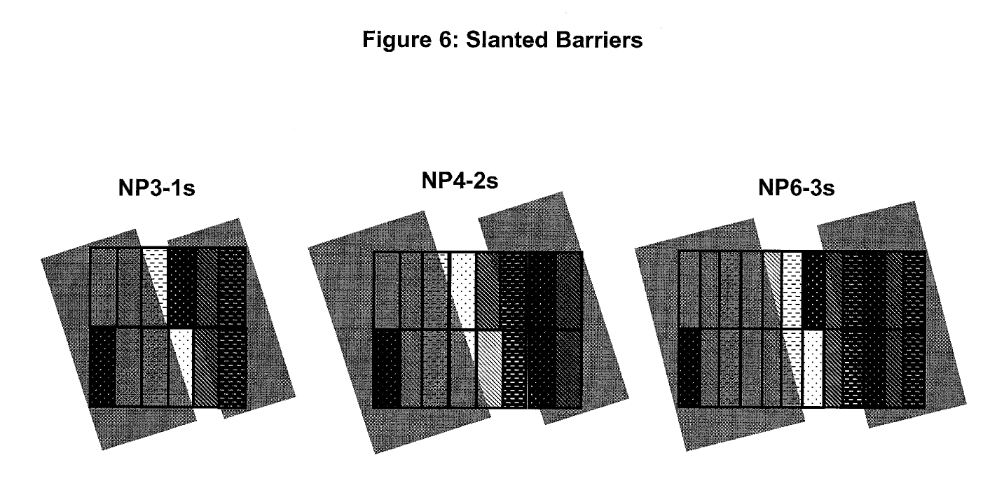

Moire is a visual artefact caused by superimposing two patterns with a similar repeating pitch. The opaque parallax barrier and opaque electronics in the display panel can produce strong Moire effects. Slanting the barrier significantly reduces Moire. FIG. 5 illustrates the problem of Moire. FIG. 6 illustrates various ‘stag’ interlacing patterns that may be used to reduce Moire. In the “stag” patterns of FIG. 6 the edges of the opaque regions of the parallax barrier are inclined with respect to the pixel columns, in each example with a slope of one sub-pixel per row of sub-pixels. Decreasing the slope of the barrier beyond 1:1 (where “decreasing” means, with respect to for example FIG. 6, making the slope closer to the horizontal) may be undesirable with portrait orientated sub-pixels since it increases the number of partially occluded sub-pixels which then causes the repeat size of the interlace pattern to be increased.

The “stag” concept and design may be applied to many types of parallax optic 41. For example, the “stag” concept and design may be applied to a parallax barrier array 31, or to a parallax optic 41 that comprises an array of lenticular elements. The “stag” concept and design may be applied to a parallax optic 41 that comprises an array of multiple faceted lenticular elements 10.

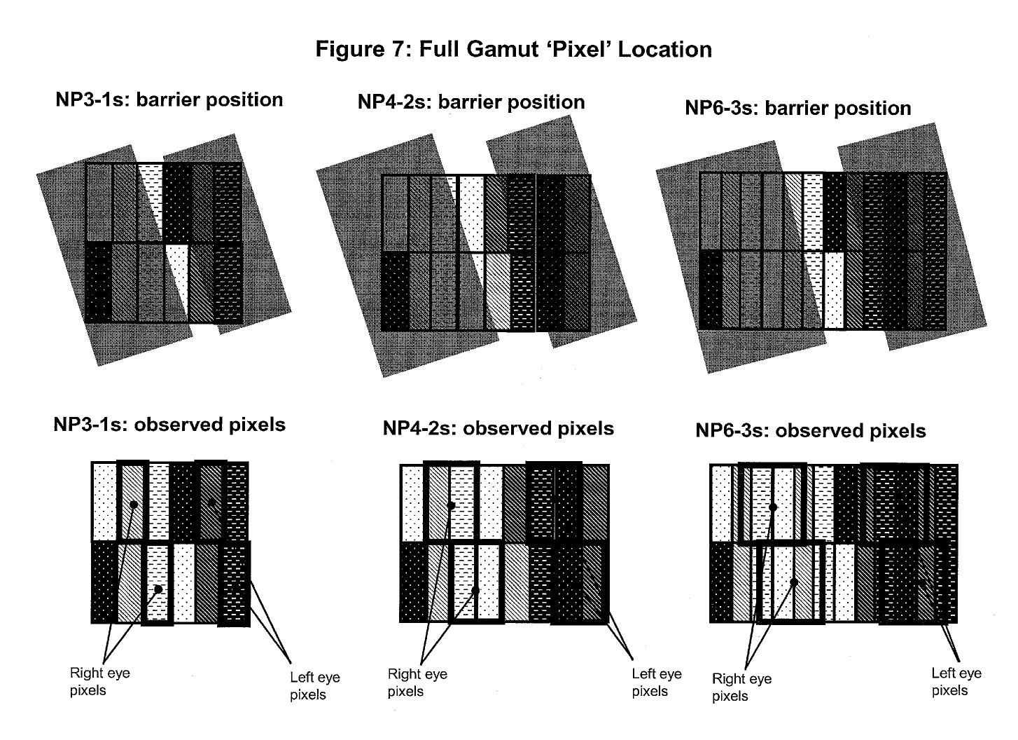

The interlacing pattern affects the image quality of the system in multiple ways. As the sub-pixel repeat number increases then left and right image regions become spatially separated, leading to a decrease in the system resolution. However, small repeat patterns can have a different type of problem, where the individual image regions are relatively closely spaced, but each row contains an unbalanced number of sub-pixels. In order to display a full gamut of three colour sub-pixels are needed, and so the effective full gamut ‘pixel’ becomes spread over a number of rows and/or columns. FIG. 7 illustrates how the NP6-3 stag1 system (NP6-3s) has superior spatial concentration of sub-pixels when compared to an NP3-1 stag1 (NP3-1s) or NP4-2 stag1 (NP4-2s) system of identical sub-pixel size. FIG. 7 illustrates the barrier positions for NP3-1s, NP4-2s and NP6-3s for an on-axis viewer. FIG. 7 also illustrates the pixels viewed by each eye by an on-axis viewer for the given barrier position. In the NP 3-1s system only one sub-pixel is visible in the barrier aperture for each eye in any row of pixels so a full gamut of three colour sub-pixels is spread over three rows (or multiple columns) of sub-pixels. In the NP4-2s only two sub-pixels are visible in the barrier aperture for each eye in any row of pixels so a full gamut of three colour sub-pixels is again spread over more than one row (or multiple column) of sub-pixels. However, in the NP6-3s system three sub-pixels (Red, Green and Blue) are visible in every barrier aperture by both the left eye and the right eye for every row.

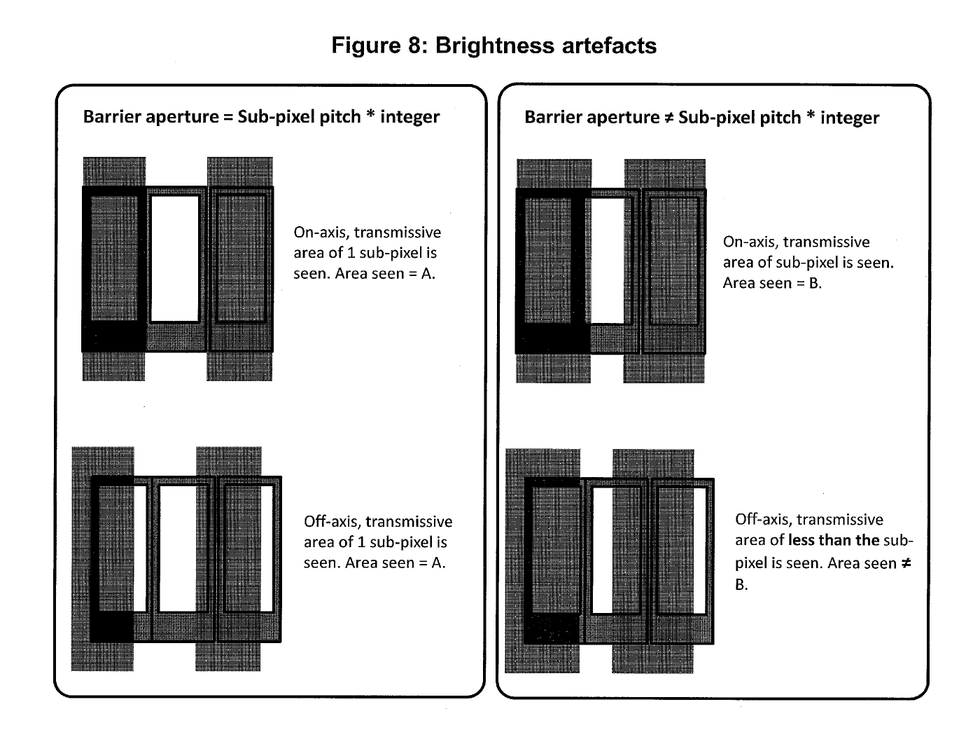

The barrier aperture width of a preferred system should be close to an integer multiple of the sub-pixel pitch. FIG. 8 shows the benefit of this design. Image sub-pixels are usually not transmissive (or reflective or transflective) over their entire area, and usually contain some regions (for example, a black mask matrix). that do not emit light, reflect light or transmits light (i.e. an area of the display not directly involved in the light modulation process). If the barrier aperture width is equal to an integer multiple of the sub-pixel pitch then a moving observer always sees an entire sub-pixel transmissive (or reflective or transflective) area regardless of lateral head position. In other words and with reference to the left hand side diagram in FIG. 8, which shows barrier aperture width equal to an integer multiple (in this case n=1) of the sub-pixel pitch, the observer sees an area A of the sub-pixel on-axis and off-axis and the display appears the same brightness for all lateral head position. If the barrier aperture width is significantly less than (or more than) an integer number of sub pixel pitches then lateral user movement will result in the amount of visible transmissive (or reflective or transflective) sub-pixel area varying. In other words and with reference to the right hand side diagram in FIG. 8, the observer sees an area B of the sub-pixel on-axis and area not equal to B off-axis and the display does not appear at the same brightness for all lateral head position The consequence of this is that the display brightness varies as the user moves since the amount of black mask area imaged to the viewer's eyes is a function of head-position. It is possible to compensate for such brightness variation with user tracking, but it is very sensitive to user position and presents a significant problem.

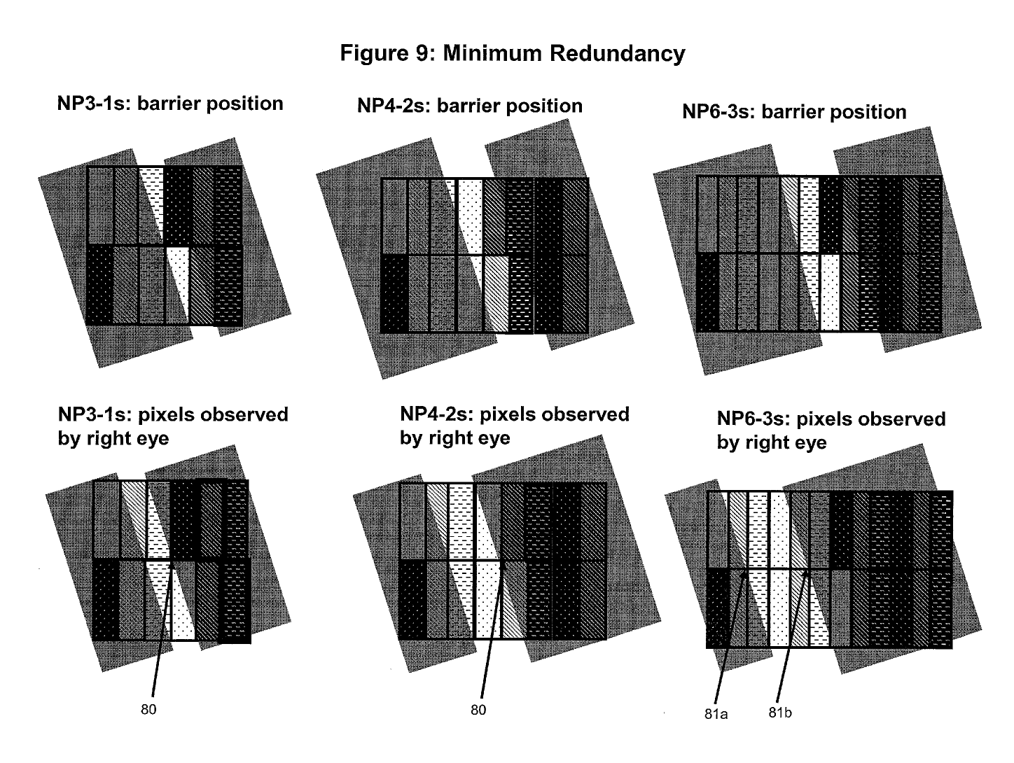

Image redundancy is preferable for smooth user tracking. Redundant sub-pixels here refer to sub-pixels not visible to either of the user's eyes for a particular position of the observer. These sub-pixels may be pre-loaded with image data so that when the user moves the appropriate eye data becomes visible. For an observer head position as shown with reference to FIG. 12A, sub-pixels (or pixels) 1, 6, 7 and 12 are redundant. For an observer head position as shown with reference to FIG. 12B, sub-pixels (or pixels) 5, 6, 11 and 12 are redundant. In order to achieve this, there must be at least one sub-pixel available either side of the sub-pixels that are currently visible to the observer. It is wasteful having any more than the minimum number of redundant sub-pixels as it causes an unnecessary reduction in the resolution and brightness of the image panel. FIG. 9 shows the barrier positions for the NP3-1s, NP4-2s and NP6-3s for an on-axis viewer. FIG. 9 also shows the pixels observed by the right eye for the NP3-1s, NP4-2s and NP6-3s for an on-axis viewer. FIG. 9 shows that the pixels observed by the right eye for the NP3-1s will include a left eye pixel (indicated by the arrow 80 at the bottom left of the left eye pixel) for a small lateral head movement to the left. FIG. 9 shows that the pixels observed by the right eye for the NP4-2s will include a left eye pixel (indicated by the arrow 80 at the bottom left of the left eye pixel) for a small lateral head movement to the left. FIG. 9 shows that the pixels observed by the right eye for the NP6-3s will include a right eye pixel (indicated by the arrow 81b at the bottom left of the right eye pixel) for a small lateral head movement to the left. FIG. 9 shows that the pixels observed by the right eye for the NP6-3s will include a right eye pixel (indicated by the arrow 81a at the top right of the right eye pixel) for a small lateral head movement to the right. Therefore FIG. 9 shows that, only the NP6-3s system contains sufficient redundancy and the NP3-1s and NP4-2s systems do not satisfy the redundancy criterion. In other words, the arrow 80 shows the corner of the sub-pixel displaying the left eye image that will be seen by the viewer's right eye for any appreciable head-movement to the left. Viewing the left eye image with the right eye (and vice versa) results in poor quality 3D images (3D crosstalk). For perfect tracking, the NP6-3s system is the smallest repeat distance that enables perfect tracking. The NP6-3s in FIG. 9 shows that a small yet measurable head-movement to the left or right will simply reveal another sub-pixel with right eye image to the right eye.

With reference to FIG. 6, FIG. 7 and FIG. 9 it will be appreciated that some pixels (or sub-pixels) have a first area that is visible and a second area that is not visible for a given head position. In other words, the slanted parallax barrier sub-divides the pixels (or sub-pixels). If a large proportion of pixels (or sub-pixels) are sub-divided, then the 3D system may have a high level of redundancy. A high level of redundancy may be good for head-freedom but may be bad for perceived resolution. A slanted barrier is a good solution for avoiding Moire problems. Colour artefacts are a function of parallax optic pitch and colour filter pitch. The NP6-3s system was found to be a surprisingly good solution for simultaneously optimising the parameters of redundancy, colour artefacts and Moire. In other words, the NP6-3s system was found to be a surprisingly good solution for simultaneously optimising good head-freedom, good perceived resolution and minimal image artefacts, such as Moire and colour artefacts.

An advantage of the NP6-3s system is the low resource overhead necessary for operation. Compared with other state-of-the-art systems, far less image processing is required. This is largely due to the brightness uniformity enabled by the integer sub-pixel-width barrier and the tolerance to user position enabled by the redundancy criterion. In order to achieve comparable performance other systems must track the user more accurately and update the display much more frequently. By contrast, the NP6-3s system is much simpler to run and may be constructed with much cheaper hardware.

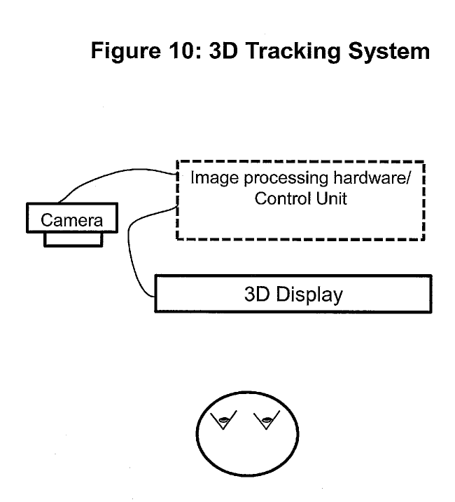

FIG. 10 shows an example of an autostereoscopic display according to the invention. Observer tracking is used in conjunction with means to determine the position of the observer (such as a camera), which provides information on the observer's position to a control unit, for example comprising suitable image processing hardware. The display comprises a 3D display with parallax optic. The image display layer of the 3D display may be addressed via the control unit (image processing hardware) with a 6 sub-pixel repeating interlace pattern, and the display may have a parallax optic slanted at a slope of 1 pixel per pixel row (or one sub-pixel per row of sub-pixels) and, in the case of a parallax barrier, an aperture width of 3 pixels (or 3 sub-pixels) to give an “NP6-3 stag1” autostereoscopic display and, as explained above, this gives very good tracking performance. As shown in FIG. 12A and FIG. 12B, the image data for left eye (L) and right eye (R) has been changed by the control unit (not shown) in response to the viewer's head movement from the first head position in FIG. 12A and the second head position in FIG. 12B. As shown in FIG. 12A, for a first head position, left eye (L) image data is addressed to pixels numbered 1, 2, 3, 4, 5 and 6 and right eye (R) image data is addressed to pixels numbered 7, 8, 9, 10, 11 and 12. As shown in FIG. 12B, for a second head position, left eye (L) image data is addressed to pixels numbered 1, 2, 3, 4, 5 and 12 and right eye (R) image data is addressed to pixels numbered 6, 7, 8, 9, 10 and 11. In response to the viewer's head movement from the first head position in FIG. 12A and the second head position in FIG. 12B the left eye image data on pixel 6 has been changed to right eye image data by the control unit. In response to the viewer's head movement from the first head position in FIG. 12A and the second head position in FIG. 12B the right eye image data on pixel 12 has been changed to left eye image data by the control unit. Good head-tracked 3D performance is partly due to the ‘redundant’ sub-pixels that are initially hidden from the user and that may be pre-loaded with view information. Correct view information can be maintained for each eye as the user moves and these hidden sub-pixels are revealed.

In a second embodiment, the invention may be implemented with a switchable parallax system that, in one mode, provides an NP6-3 stag 1 display. The barrier may for example be implemented in a liquid crystal (or other electro-optic material) panel that is switchable in a discrete manner with electrodes used to control spatial transmissivity. The barrier features can then be moved to track the position of the user. Such a parallax barrier may be disableable, that is may be switched into a transmissive mode so that the full resolution of the base image display panel is seen in a 2D display mode. Such a system may also give brightness advantages over a fixed barrier design.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

For example, although the invention has been primarily described with reference to an NP6-3 stag 1 display that includes a parallax barrier aperture array having parallax elements constituted by alternating transmissive regions (“apertures”) and opaque regions (“barriers”), the invention is not limited to this specific parallax system. The invention may for example be implemented with an NP6-3 stag 1 display in which the parallax optic comprises a lenticular array (in which the axes of the lenticular elements, or the axes of the columns of lenses in a case where a separate lens is associated with each pixel or sub-pixel, are inclined with respect to the pixel or sub-pixel columns). The lenticular array may be of the multi-faceted type, for example as described as by US20120229896.

It should also be noted that the invention is not limited solely to an NP6-3 stag 1 display, but may be more generally applied to an NPX-Y stag display where Y≧3 and X−Y≧3. A display for which X−Y>3, for example, will contain more “redundant” pixels or sub-pixels that are available to be preloaded with image data that will become visible when the observer's head moves than an NP6-3 stag 1 display. As noted a greater number of “redundant” pixels will result in a greater reduction in brightness and a greater reduction is resolution, and it is therefore usually desirable to keep the number of redundant pixels to the minimum required to allow preloading of image data, ie to have X−Y=3. However, there may in principle be applications where the improved 3-D image quality provided to a moving observer by a display having X−Y>3 would outweigh the greater loss of brightness and resolution.

In a display of the present invention, parallax elements of the parallax optic may be inclined with respect to the columns of pixels or sub-pixels of the image display panel at an inclination of one pixel per row of pixels or of one sub-pixel per row of sub-pixels. A greater inclination than this may be undesirable, particularly in the case of sub-pixels having a portrait format, since it increases the number of partially occluded sub-pixels which then causes the repeat size of the interlace pattern to be increased.

X−Y may equal 3. This provides that, for a parallax optic with elements inclined at one pixel per row of pixels or at one sub-pixel per row of sub-pixel, there is one and only one, “redundant” pixel or sub-pixel at each side of area of the image display panel visible through an element of the parallax optic. This is the minimum number of “redundant” pixels or sub-pixels required to be pre-loaded with image data that will become visible if the observer moves their head, and thereby provide improved 3-D image quality to a moving observer. Providing only the minimum number of “redundant” pixels minimises the reduction in brightness and resolution caused by the provision of “redundant” pixels.

Y may equal 3. In the case of a full colour display with sub-pixels of three different colours, this provides a full colour pixel gamut on a single row or column of sub-pixels.

X may be equal to 6 and Y may be equal to 3.

The parallax optic may be a parallax barrier aperture array. In this case, the transmissive apertures of the parallax barrier aperture array may have a width of Y columns of pixels or sub-pixels. The parallax optic pitch may be substantially equal to 2X—this pitch is generally found to provide good display qualities.

Alternatively, the parallax optic may be a lenticular parallax optic. In this case, the lenses or lenticular elements of the parallax optic may have a width, parallel to the image display panel, of 2X adjacent columns of pixels or sub-pixels. The parallax optic pitch may again be substantially equal to 2X. In the case that X=6 and Y=3, then a parallax optic pitch of 2X is equivalent to 4Y.

The parallax optic may comprise an array of multi-faceted lenses. Each lens may comprise 4 facets, and each facet may have a width, parallel to the image display panel, of Y adjacent columns of pixels or sub-pixels. This provides a lens width equal to 4Y columns of pixels or sub-pixels allowing a parallax optic pitch substantially equal to 4Y—that is, in the case that X=6 and Y=3, allowing a parallax optic pitch substantially equal to 2X.

The parallax optic may be disableable. This allows the display to operate in a conventional 2-D mode by disabling the parallax optic and addressing the image display layer to display a single image.

The control unit may be configured to address the image display panel to display left eye and right-eye images on the respective sets of X adjacent columns of pixels or sub-pixels.

The display may comprise an observer tracking device for determining a position of an observer.

The control unit may be configured to address the image display panel in dependence on a position of the observer determined by the observer tracking device.

### INDUSTRIAL APPLICABILITY

This system could be used to deliver high quality tracked autostereoscopic 3D.

1. A multiple view directional display comprising: an image display panel having a matrix of pixels or sub-pixels arranged in rows and columns; a parallax optic disposed in the path of light through the image display panel; and a control unit for addressing the pixels or sub-pixels;
wherein the control unit is configured to address the image display panel to display a first image on a first set of X adjacent columns of pixels or sub-pixels and a second image on a second set of X adjacent columns of pixels or sub-pixels, the first set being different from the second set;
wherein the parallax optic comprises parallax elements configured to allow a first region of the image display panel having a width of Y adjacent columns of pixels or sub-pixels to be visible to a viewer's left eye, wherein the first region comprises a sub-set of the first set of X adjacent columns of pixels or sub-pixels and to allow a second region of the image display panel which is different to the first region and having a width of Y adjacent columns of pixels or sub-pixels to be visible to the viewer's right eye, wherein the second region comprises a sub-set of the second set of X adjacent columns of pixels or sub-pixels;
wherein Y≧3 and X−Y≧3; and
wherein parallax elements of the parallax optic are inclined with respect to columns of pixels or sub-pixels of the image display panel.

2. A display as claimed in claim 1 wherein parallax elements of the parallax optic are inclined with respect to the columns of pixels or sub-pixels of the image display panel at an inclination of one pixel per row of pixels or of one sub-pixel per row of sub-pixels.

3. A display as claimed in claim 1 wherein X−Y=3.

4. A display as claimed in claim 1 wherein Y=3.

5. A display as claimed in claim 1 wherein X=6 and Y=3.

6. A display as claimed in claim 1 wherein the parallax optic is a parallax barrier aperture array.

7. A display as claimed in claim 6 wherein apertures of the parallax barrier aperture array have a width of Y adjacent columns of pixels or sub-pixels.

8. A display as claimed in claim 1 wherein the parallax optic is a lenticular parallax optic.

9. A display as claimed in claim 8 wherein the parallax optic comprises an array of lenses, each lens having a width, parallel to the image display panel, of 2X adjacent columns of pixels or sub-pixels.

10. A display as claimed in claim 8 wherein the parallax optic comprises an array of multi-faceted lenses.

11. A display as claimed in claim 10 wherein each lens comprises 4 facets each facet having a width, parallel to the image display panel, of Y adjacent columns of pixels or sub-pixels.

12. A display as claimed in claim 1 wherein the parallax optic is disableable.

13. A display as claimed in claim 1, wherein the control unit is configured to address the image display panel to display left eye and right-eye images on the respective sets of X adjacent columns of pixels or sub-pixels.

14. A display as claimed in claim 1 and comprising an observer tracking device for determining a position of an observer.

15. A display as claimed in claim 14 wherein the control unit is configured to address the image display panel in dependence on a position of the observer determined by the observer tracking device.

16. A multiple view directional display comprising: an image display panel having a matrix of pixels or sub-pixels arranged in rows and columns; a parallax optic disposed in the path of light through the image display panel; and a control unit for addressing the pixels or sub-pixels;
wherein the control unit is configured to address the image display panel to display a first image on a first set of X adjacent columns of pixels or sub-pixels and a second image on a second set of X adjacent columns of pixels or sub-pixels, the first set being different from the second set;
wherein the parallax optic comprises parallax elements configured to allow a first region of the image display panel having a width of Y adjacent columns of pixels or sub-pixels to be visible to a viewer's left eye, wherein the first region comprises a sub-set of the first set of X adjacent columns of pixels or sub-pixels and to allow a second region of the image display panel which is different to the first region and having a width of Y adjacent columns of pixels or sub-pixels to be visible to the viewer's right eye, wherein the second region comprises a sub-set of the second set of X adjacent columns of pixels or sub-pixels;
wherein Y≧3 and X−Y≧3;
wherein parallax elements of the parallax optic are inclined with respect to columns of pixels or sub-pixels of the image display panel;
wherein parallax elements of the parallax optic are inclined with respect to the columns of pixels or sub-pixels of the image display panel at an inclination of one pixel per row of pixels or of one sub-pixel per row of sub-pixels; and
wherein X=6 and Y=3.

17. A multiple view directional display comprising: an image display panel having a matrix of pixels or sub-pixels arranged in rows and columns; a parallax optic disposed in the path of light through the image display panel; and a control unit for addressing the pixels or sub-pixels;
wherein the control unit is configured to address the image display panel to display a first image on a first set of X adjacent columns of pixels or sub-pixels and a second image on a second set of X adjacent columns of pixels or sub-pixels, the first set being different from the second set;
wherein the parallax optic comprises parallax elements configured to allow a first region of the image display panel having a width of Y adjacent columns of pixels or sub-pixels to be visible to a viewer's left eye, wherein the first region comprises a sub-set of the first set of X adjacent columns of pixels or sub-pixels and to allow a second region of the image display panel which is different to the first region and having a width of Y adjacent columns of pixels or sub-pixels to be visible to the viewer's right eye, wherein the second region comprises a sub-set of the second set of X adjacent columns of pixels or sub-pixels;
wherein Y≧3 and X−Y≧3;
wherein parallax elements of the parallax optic are inclined with respect to columns of pixels or sub-pixels of the image display panel;
wherein X=6 and Y=3;
wherein the parallax optic is a parallax barrier aperture array; and
wherein apertures of the parallax barrier aperture array have a width of Y adjacent columns of pixels or sub-pixels.

18. A multiple view directional display comprising: an image display panel having a matrix of pixels or sub-pixels arranged in rows and columns; a parallax optic disposed in the path of light through the image display panel; and a control unit for addressing the pixels or sub-pixels;
wherein the control unit is configured to address the image display panel to display a first image on a first set of X adjacent columns of pixels or sub-pixels and a second image on a second set of X adjacent columns of pixels or sub-pixels, the first set being different from the second set;
wherein the parallax optic comprises parallax elements configured to allow a first region of the image display panel having a width of Y adjacent columns of pixels or sub-pixels to be visible to a viewer's left eye, wherein the first region comprises a sub-set of the first set of X adjacent columns of pixels or sub-pixels and to allow a second region of the image display panel which is different to the first region and having a width of Y adjacent columns of pixels or sub-pixels to be visible to the viewer's right eye, wherein the second region comprises a sub-set of the second set of X adjacent columns of pixels or sub-pixels;
wherein Y≧3 and X−Y≧3;
wherein parallax elements of the parallax optic are inclined with respect to columns of pixels or sub-pixels of the image display panel;
wherein X=6 and Y=3;
wherein the parallax optic is a lenticular parallax optic; and
wherein the parallax optic comprises an array of lenses, each lens having a width, parallel to the image display panel, of 2X adjacent columns of pixels or sub-pixels.

19. A multiple view directional display comprising: an image display panel having a matrix of pixels or sub-pixels arranged in rows and columns; a parallax optic disposed in the path of light through the image display panel; and a control unit for addressing the pixels or sub-pixels;
wherein the control unit is configured to address the image display panel to display a first image on a first set of X adjacent columns of pixels or sub-pixels and a second image on a second set of X adjacent columns of pixels or sub-pixels, the first set being different from the second set;
wherein the parallax optic comprises parallax elements configured to allow a first region of the image display panel having a width of Y adjacent columns of pixels or sub-pixels to be visible to a viewer's left eye, wherein the first region comprises a sub-set of the first set of X adjacent columns of pixels or sub-pixels and to allow a second region of the image display panel which is different to the first region and having a width of Y adjacent columns of pixels or sub-pixels to be visible to the viewer's right eye, wherein the second region comprises a sub-set of the second set of X adjacent columns of pixels or sub-pixels;
wherein Y≧3 and X−Y≧3;
wherein parallax elements of the parallax optic are inclined with respect to columns of pixels or sub-pixels of the image display panel;
wherein parallax elements of the parallax optic are inclined with respect to the columns of pixels or sub-pixels of the image display panel at an inclination of one pixel per row of pixels or of one sub-pixel per row of sub-pixels;
wherein X=6 and Y=3;
wherein the parallax optic is a parallax barrier aperture array; and
wherein apertures of the parallax barrier aperture array have a width of Y adjacent columns of pixels or sub-pixels.

20. A multiple view directional display comprising: an image display panel having a matrix of pixels or sub-pixels arranged in rows and columns; a parallax optic disposed in the path of light through the image display panel; and a control unit for addressing the pixels or sub-pixels;
wherein the control unit is configured to address the image display panel to display a first image on a first set of X adjacent columns of pixels or sub-pixels and a second image on a second set of X adjacent columns of pixels or sub-pixels, the first set being different from the second set;
wherein the parallax optic comprises parallax elements configured to allow a first region of the image display panel having a width of Y adjacent columns of pixels or sub-pixels to be visible to a viewer's left eye, wherein the first region comprises a sub-set of the first set of X adjacent columns of pixels or sub-pixels and to allow a second region of the image display panel which is different to the first region and having a width of Y adjacent columns of pixels or sub-pixels to be visible to the viewer's right eye, wherein the second region comprises a sub-set of the second set of X adjacent columns of pixels or sub-pixels;
wherein Y≧3 and X−Y≧3;
wherein parallax elements of the parallax optic are inclined with respect to columns of pixels or sub-pixels of the image display panel;
wherein parallax elements of the parallax optic are inclined with respect to the columns of pixels or sub-pixels of the image display panel at an inclination of one pixel per row of pixels or of one sub-pixel per row of sub-pixels;
wherein X=6 and Y=3;
wherein the parallax optic is a lenticular parallax optic; and
wherein the parallax optic comprises an array of lenses, each lens having a width, parallel to the image display panel, of 2X adjacent columns of pixels or sub-pixels.
